(19) United States
(12) Patent Application Publication
(10) Pub. No.: US 2002/0045388 A1
(43) Pub. Date: Apr. 18, 2002

(54) Electrical connector and terminal

(75) Inventor: Takeya Miwa, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 09/973,463

(22) Filed: Oct. 11, 2001

(30) Foreign Application Priority Data
Oct. 16, 2000 (JP) 2000-314911

(51) Int. Cl. H01R 4/10

(52) U.S. Cl. 439/877

(57) ABSTRACT

Objects of this Invention

Reliability and productivity of electrical connection is enhanced by means of preventing centering error of the electrical contact of the terminal.

How to be Solved

An electrical connector comprises a terminal 15, which is provided at one end thereof with an electrical contact portion 16 for connecting with a mating terminal and at the other end with an electric wire joint portion 18 for an electric wire 40, and a connector housing 1 which is provided with a terminal receiving section 6 and receives the terminal 15, wherein the terminal receiving section 6 provides an extra room for the electrical contact portion 16, wherein the electrical contact portion 16 and the electric wire joint portion 18 are connected with a flexible connecting part 20. The connecting part 20 is formed into sheet shape extending from a bottom base plate 26 of the electrical contact portion 16. The connecting part 20 is provided at both sides with a couple of cutouts 21. The connecting part 20 has narrower width than that of the bottom base plate 26 of the electrical contact portion 16 and that of the bottom base plate 27 of the electric wire joint portion 18.

### BACKGROUND OF THE INVENTION

1. Field of the Invention

This invention relates to terminals and an electrical connector with a connector housing receiving electric conductive terminals for achieving reliable electrical connection by low insertion force to relieve centering error between corresponded terminals.

2. Description of the Related Art

FIG. 6 shows one example of electrical connectors by prior art.

An electrical connector 75 comprises a connector housing 50 which terminal receiving section 51 receives so-called female type terminals 60. The terminal 60-is made with sheet material by punching and bending process. The terminal 60 is provided with an electrical contact portion 62 for connecting to a mating terminal and an electric wire joint portion 67 for joining to an electric wire 40.

The electrical contact portion 62 is formed into box-like shape with a base plate 63, a couple of side walls 64a, 64b standing at both sides of the base plate 63 and a top plate 65 by bending inwardly the top edges of both side walls 64a, 64b, and has a curved spring contact piece inside for electrically contacting to an electrical contact portion of a mating terminal.

The electric wire joint portion 67 is formed into U-shape in cross section with the base plate 63 and a couple of side walls 64a, 64b standing at both sides of the base plate 63. Opening at the top is for putting pressure from upside on laid electric wire 40. The electric wire joint portion 67 includes a core wire pressure contact portion 68 in almost the center thereof and a cover press contact portion 69 at rear side. The core wire pressure contact portion 68 is formed into a set of U-shape slit with a couple of pressure contact pieces 70 and in this example, three sets are provided. The covered electric wire 40 is connected with a pressure contact tool. Pressing fit the covered electric wire 40 into U-shape slits performs pealing a cover and connecting a conductor simultaneously. The cover press contact portion 69 is for holding the electric wire 40 by bending clamping pieces 71 to prevent the wire slip off.

FIG. 7 shows condition that the terminal 60 is received into the terminal receiving section 51 of the connector housing 50. The terminal receiving section 51 has some extra room for the terminal 60. When the electric wire 40 is press-fitted into the terminal, the electric wire joint portion 67 swells in its width (y direction) and it makes the extra room lost. Therefore, position of the terminal 60 is limited in directions of the length (x direction), width and height (z direction).

An electrical contact portion of a mating terminal (not shown) is guided by the electrical contact portion 62 of this electrical connector 75 and inserted simultaneously while bending the spring contact piece downward and then clamped by upward spring force of the spring contact piece.

3. Objects to be Solved

However, the electrical connector by prior art, as mentioned above, could not be inserted with low insertion force and the electrical contact portion may be deformed or broken and the spring contact piece may be damaged in case of existing centering error between an electrical contact portions of a female type terminal and a male type terminal. Even if the connector can be inserted with low insertion force, condition of contacting to the spring contact piece may be bad and it may bring unreliable electrical connection. In case of inserting the terminal unnaturally, possibility of such a trouble is high. It is caused by holding a female type terminal in condition of leaving the centering error between terminals. In other words, if the centering error can be relieved, such troubles by centering error can be solved.

Furthermore, since the cover press contact portion is located at rear area of the electrical contact portion, the terminal length increases and size of the connector increases on the length. Increasing connector size opposes trend of car component down sizing and its improvement is required.

This invention has been accomplished to overcome the above drawbacks and an object of this invention is to provide an electrical connector which can relieve centering error between terminals of both electrical contact portion and serve electrical connection reliably with low insertion force, even if centering error between electrical contact portions of one and other terminals exists, and also increasing size of the length of the connector is prevented.

4. How to Attain the Object

In order to attain the objects, there is provided a electrical connector which comprises a connector housing including terminal receiving sections and a terminal having an electrical contact portion at one end thereof for connecting to a mating terminal and an electric wire joint portion at the other end for joining to an electric wire, wherein the terminal receiving section has an extra room for allowing the electrical contact portion to move, wherein the electrical contact portion and the electric wire joint portion are connected by means of a flexible connecting part (claim 1).

Preferably, said flexible connecting part is formed into a sheet shape, extending from a bottom base plate of the electrical contact portion (claim 2). Preferably, said flexible connecting part is provided, at the both sides, with a couple of cutouts and the width of said flexible connecting part is narrower than that of the bottom base plates of the electrical contact portion and that of the electric wire joint portion (claim 3). Preferably, the connector housing is provided, at the terminal receiving section, with a pair of partition walls for dividing the terminal receiving section into the front and the rear in the length of the section and the pair of partition walls hold the terminal at the cutouts of the terminal (claim 4).

Furthermore, the connector housing is provided on both side walls of a rear portion of the terminal receiving section with a pair of projections, projecting inwardly from the terminal receiving section, for holding an electric wire (claim 5). Preferably, the pair of projections are flexible in a radial direction of the electric wire (claim 6).

A terminal comprises an electrical contact portion at one end thereof for connecting to a mating terminal and an electric wire joint portion at the other end for joining to an electric wire, wherein the electrical contact portion and the electric wire joint portion are connected by means of a flexible connecting part (claim 7). The flexible connecting part of the terminal according to claim 5 is formed into a sheet shape, extending from a bottom base plate of the electrical contact portion (claim 8). Preferably, the flexible connecting part of the terminal according to claims 7 or 8 is provided, at the both sides, with a couple of cutouts and the width of said flexible connecting part is narrower than that of the bottom base plates of the electrical contact portion and that of the electric wire joint portion (claim 9).

Acting and effects according to above claims will be described as following.

In case of claim 1 of this invention, when an electric wire is press-fitted into the pressure contact portion of the terminal, the electric wire joint portion swells in its width and side walls of the electric wire joint portion contact the terminal receiving section and the terminal is fixed. However, the electrical contact potion can move in extra room. And also the electrical contact portion can move easily since bending stiffness of the flexible connecting part is low.

In case of claim 2 of this invention, the electrical contact portion can move not only in a width direction but also in a sheet thickness direction (height direction) since the flexible connecting part is formed into a sheet shape. In case of claim 3 of this invention, the electrical contact portion can move easily since the flexible connecting part is provided with cutouts to be narrow width and then the bending stiffness goes down. In case of claim 4 of this invention, the electrical contact portion can move in width and height directions on the narrow flexible connecting part as a fulcrum since the flexible connecting part of the terminal is held by a pair of partition walls. In case of claims 5, 6 of this invention, an electric wire slipping off is prevented since the projections are provided in the terminal receiving section.

In case of claims 7, 8 of this invention, the electrical contact portion can move since the flexible connecting part of the terminal is flexible. In case of claim 9 of this invention, the electrical contact portion can move more easily since the flexible connecting part is formed to narrow width.

### EFFECTS OF THE INVENTION

According to claim 1 of this invention, as mentioned above, centering error between each electrical contact portion of the male type terminal and the female terminal is relieved and reliability of electrical connection can be ensured since the electrical contact portion of the terminal can move in the extra room. And also the electrical connectors can be connected easily with low insertion force.

According to claim 2 of this invention, the connection is deflected in a thickness direction and then centering error in two-dimensional directions can be relieved. Therefore, the effect by claim 1 is enhanced. According to claim 3 of this invention, the bending stiffness goes down more and the electrical contact portion can move easily since the connecting part is provided with cutouts and formed into narrow width. It is effected similarly as claim 1 or 2 in this invention.

According to claim 4 of this invention, in case of existing centering error between terminals, the centering error can be relieved and reliability of electrical connection can be enhanced since the connecting part of the terminal is held by a pair of partition walls and the electrical contact portion can move easily on the narrow width connecting part 20 as a fulcrum. Furthermore, since engaging the partition walls with the cutouts of the terminal prevents terminal draw-out at the rear, the terminal or the connector is not required to have engaging means and then, manufacturing cost can be reduced.

According to claim 5 or 6 of this invention, the terminal receiving section is provided with a pair of projections and they prevent electric wire slip-off. Therefore, the electric wire joint portion of the terminal is not required to provide a cover press contact portion and then length of the terminal can be shortened and the electrical connector can be miniaturized in the length.

According to claim 7 or 8 of this invention, the electrical contact portion of the terminal can move easily since bending stiffness of the connecting part is low. Therefore, electrical connection can be ensured. And also the mating terminal can be inserted easily with low insertion force. According to claim 9 of this invention, since the connecting part is formed into narrow width and the bending stiffness is low, the effect by claim 7 or 8 in this invention is enhanced.

### BRIEF DESCRIPTION OF THE DRAWINGS

FIG. 1 is a perspective view of a terminal, showing one embodiment according to this invention;

FIG. 2 is a sectional view taken along the line A-A of the terminal shown in FIG. 1;

FIG. 3 is a perspective view of a partial main area, showing one embodiment of a connector housing of an electrical connector according to this invention;

FIG. 4 is a perspective view, showing condition of inserting an electric wire into a connector housing shown in FIG. 3;

FIGS. 5A, 5B are sectional views, showing condition of assembling a terminal shown in FIG. 1 into a connector housing shown in FIG. 3 and FIG. 5A shows before jointing an electric wire and FIG. 5B shows after jointing an electric wire;

FIG. 6 is a perspective view of one embodiment of a terminal by prior art; and

FIG. 7 is a sectional view, showing condition of assembling a terminal into a connector housing shown in FIG. 6.

### DESCRIPTION OF THE PREFERRED EMBODIMENT

One embodiment of this invention will now be described with reference to the attached drawings.

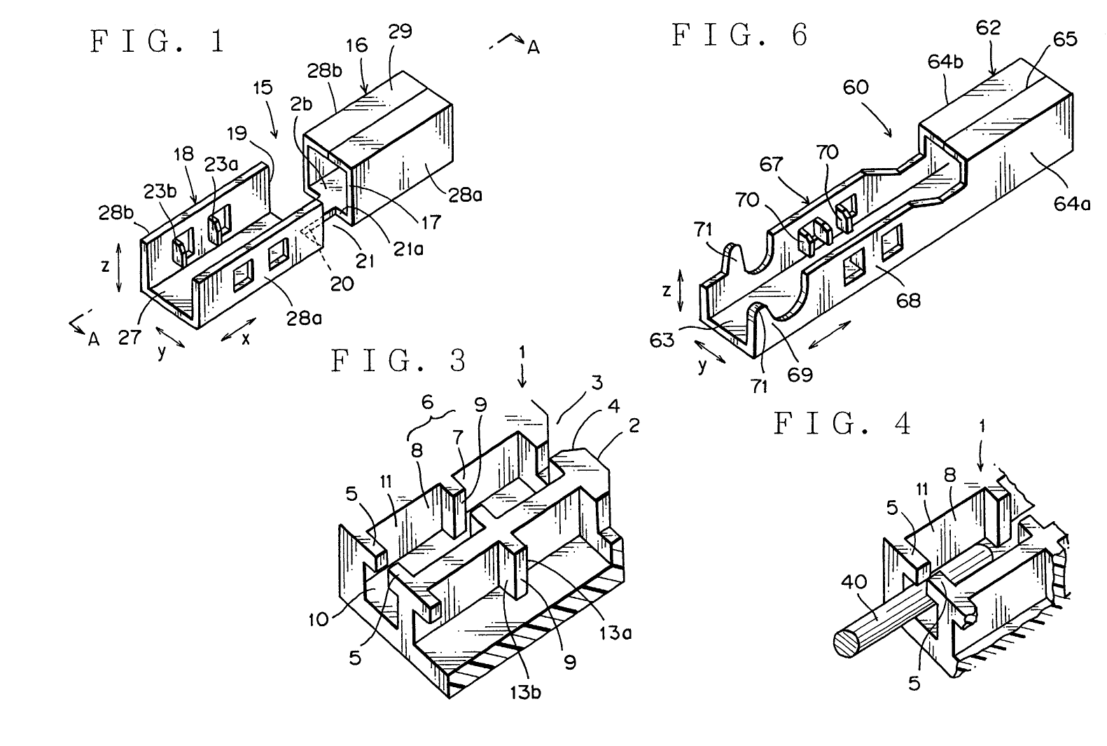

FIGS. 1-5 show one embodiment of an electrical connector and a terminal according to this invention.

FIG. 1 shows a female terminal 15 that is received into housing 1 of an electrical connector 35. The term “electrical connector” used herein is intended to mean a connector wherein the terminal 15 is received into the connector housing 1. This drawing shows the condition before connecting an electric wire 40. The terminal 15 is made of electrically conductive sheet metal by punching and bending. The male type electrical connector 35 works by receiving this terminal 15 one-on-one into a terminal receiving groove (terminal receiving section) 6 of the connector housing, described later.

The terminal 15 is provided at one end thereof with a rectangular box shape electrical contact portion 16 and at the other end with an electric wire joint portion 18. The electrical contact portion 16 is connected to the electric wire joint portion 18 by mean of a sheet shape connecting part 20. The electrical contact portion 16 is formed into rectangular box shape with a base plate 26 extending in the length, side walls 28a, 28b standing at both sides of the base plate 26 and a top plate 29 by bending inwardly the top edges of both side walls 28a, 28b.

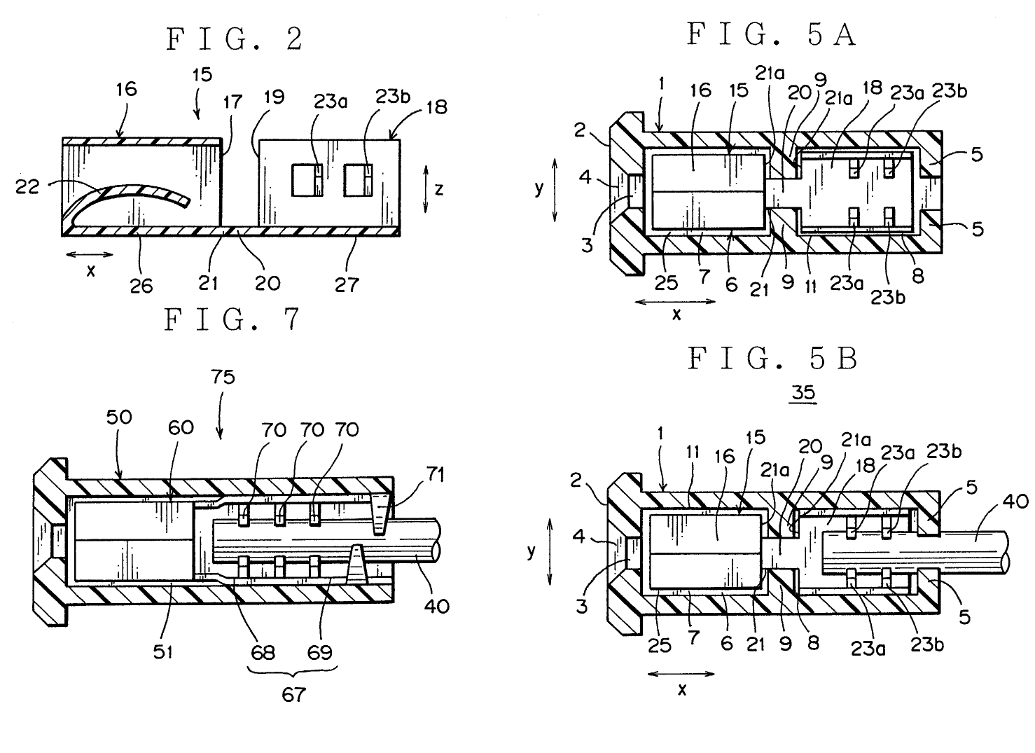

FIG. 2 shows a vertical sectional view taken along the line A-A of the female terminal shown in FIG. 1. The electrical contact portion 16 has a convexly curved spring contact piece 22 inside for contacting to an electrical contact portion (not shown) of a mating terminal. Contact pressure of the electrical contact portion is enlarged and its contact reliability is kept by the spring contact piece 22. If the stiffness of the spring contact piece 22 is too large, an electrical contact portion can not be inserted smoothly and then it may be bent or broken. Therefore, the spring contact piece 22 is adjusted to have suitable stiffness.

The electric wire joint portion 18 is formed into U-shape in cross section with a bottom base plate 27 and both side walls 28a, 28b standing at the both sides of the bottom base plate 27. The both side walls 28a, 28b are provided with pressure contact pieces 23a, 23b which are bent inwardly with partial die cutting. The pressure, contact pieces 23a, 23b of the both side walls are formed facing to each other. In this embodiment, two sets of such pressure contact pieces 23a, 23b are placed in the length direction (x direction) and placing three sets also effects like the example by prior art.

Two sets of the pressure contact pieces 23a, 23b form U-shape slits narrower than a conductor of the electric wire. Cutting edges are provided on the top of the slit to cut cover portion of the electric wire 40 and expose the conductor. The cutting edges are formed into Y-shape of 90 degree opening angle, however, the opening angle is selectable and smaller angle than 90 degree is also effective.

The connecting part 20 is formed into sheet shape, extending backward of the electrical contact portion 16. Forming sheet shape is to have low stiffness for easily elastic bending. Therefore, the electrical contact portion 16 can be moved in the extra room and the centering error for the electrical contact portion of the mating terminal is relieved. The connecting part 20 is for electrically connecting between the electrical contact portion 16 and the electric wire joint portion 18 so that high stiffness is not required to perform its function. The deference between this invention and prior art is that the connecting part of the terminal by prior art is formed into U-shape and has high stiffness with side walls, standing at both ends of a base plate along whole length, as mentioned above.

The electrical contact portion 16, the connecting part 20 and the electric wire joint portion 18 is formed as one piece by punching and bending electrical conductive sheet material. Therefore, even if the connecting part 20 is formed into narrow width or by thin thickness sheet, electrical conductivity is kept.

FIG. 3 shows a terminal receiving groove 6 of the connector housing 1 for receiving the terminal 15 shown in FIG. 1. The actual connector housing 1 is provided with juxtaposed plural terminal receiving grooves 6 to make the whole. The connector housing 1 has no top wall on the top to be opened. Stacking the connector housing 1 in multi-layer makes each top wall for each connector housing. Not-shown top lid is placed on the highest connector housing.

Generally the pressure contact terminal 15 joined with the electric wire 40 by pressure contact is inserted from rear side of the connector housing 1. However, the terminal 15 shown in FIG. 1 is inserted from the top of the housing 1 shown in FIG. 3. The reason is that the terminal receiving groove 6 is separated to front and rear in the length by a partition wall 9 to lock the cutout 21 of the terminal 15. The electrical contact portion 16 is received in the front partitioned portion 7 of the separated terminal receiving groove 6 and the electric wire joint portion 18 is received in the rear partitioned portion 8 of the separated terminal receiving groove 6.

Vertical surfaces 13a, 13b of the partition wall 9 are used to lock the terminal 15 for position control in the length. A cutout step 21a of the connecting part 20 is a locking surface to contact to a locking surface of the partition wall 9. Therefore, position of the terminal 15 is controlled in the length and at the same time it is prevented for falling off backward.

A insertion opening 3 for inserting an electrical contact portion of mating terminal is placed at a mating front surface 2 of the connector housing 1. The insertion opening 3 is formed into upside opened U-shape and at front surface side with a taper 4. Forming the taper 4 is to eliminate sticking on insertion and to insert terminals with low insertion force.

FIG. 4 shows condition of the connector housing 1 assembled with an electric wire. The connector housing 1 is provided, on both side walls 11 of a rear partitioned portion 8 (the terminal receiving groove 6), with a pair of projections 5, projecting inwardly rear partitioned portion 8, for preventing slip-off of the electric wire 40. A gap between a pair of projections 5 is smaller than the diameter of the electric wire 40 but the projections are flexible in an inserting direction (electric wire radial direction) from topside in condition of laying down the electric wire 40. Therefore, the electric wire can be mounted easily. After mounting, the electric wire 40 is pressed by the projections 5 and held.

Since the connector housing 1 according to this invention is provided with a pair of projections 5, it is not required to be formed with a cover press contact portion, at rear side of the electric wire joint portion 18, which is required in case of a terminal by prior art. Then the terminal 15 can be smaller. The electric wire 40 is clamped by pressure contact pieces 23a, 23b and then there is no concern for slip-off rearwardly in the length.

FIGS. 5A, 5B show appearances of the connector housing 1, shown in FIG. 3, receiving the terminal 15, shown in FIG. 1. FIG. 5A shows an appearance before connecting an electric wire and FIG. 5B shows an appearance after connecting an electric wire. Since the bottom base plates 26, 27 of the terminal 15 are in the same plane between the electrical contact portion 16 and the electric wire joint portion 18, the terminal 15 is placed stably and its positioning accuracy in a height direction (z direction) is also good. On the other hand, as shown in FIG. 5B, there is a small clearance as an extra room for insertion in a width direction (y direction) between the electrical contact portion 16 or the electric wire joint portion 18 and the side wall 11 of the terminal receiving groove 6.

When press-fitting the electric wire 40 into the electric wire joint portion 18, the electric wire joint portion 18 swells in a radial direction as shown in FIG. 5B and pushes the side wall 11 of the rear partitioned portion 8 so that the extra room is absorbed. However, a clearance between the electrical contact portion 16 and the side wall 11 of the front partitioned portion 7 is still kept and the extra room is not absorbed.

Since the terminal 15 is held with no datum surface in a width direction, positioning accuracy in a width direction is relatively worse than that in a height direction. Therefore, there is possibly a centering error between an electrical contact portion of a male type terminal and the electrical contact portion 16 of the female type terminal 15. In case of a centering error existing, inserting an electrical contact portion may cause damaging the spring contact piece 22 or breaking an electrical contact portion itself and then reducing reliability of electrical connection.

To overcome the above drawbacks, according to this invention, the front partitioned portion 7 has the extra room 25 for allowing the electrical contact portion 16 to move and the electrical contact portion 16 can move in width and height directions on the low stiffness connecting part 20 as a fulcrum. In short, when inserting an electrical contact portion of a mating terminal, the electrical contact portion 16 of the female type terminal 15 can move to make the center of the electrical contact portions of both terminals correspondent.

The connecting part 20 is formed into sheet shape for allowing the electrical contact portion 16 to move easily and its both sides have a cutout to be narrow wide. A deflection of the electrical contact portion 16 on the connecting part 20 as a fulcrum depends on cross sectional property of the connecting part 20 and especially a deflection in width direction depends closely on a width of the connecting part 20. When keeping the same sheet thickness, a deflection is inversely proportional to cubic width. Therefore, according to this invention, the connection 20 is formed into sheet shape and also formed into narrow width by means of providing the cutouts 21.

What is claimed is:

1. An electrical connector comprising;
a connector housing including terminal receiving sections; and
a terminal having an electrical contact portion at one end thereof for connecting to a mating terminal and an electric wire joint portion at the other end for joining to an electric wire, wherein the terminal receiving section has an extra room for allowing said electrical contact portion to move, wherein the electrical contact portion and the electric wire joint portion are connected by means of a flexible connecting part.

2. The electrical connector according to claim 1, wherein said flexible connecting part is formed into a sheet shape, extending from a bottom base plate of the electrical contact portion.

3. The electrical connector according to claim 1 or 2, wherein said flexible connecting part is provided, at the both sides, with a couple of cutouts and the width of said connecting part is narrower than that of the bottom base plates of the electrical contact portion and that of the electric wire joint portion.

4. The electrical connector according to any one of claims 1, 2 and 3, wherein the connector housing is provided at the terminal receiving section with a pair of partition walls for dividing the terminal receiving section into the front and the rear in the length of the section and the pair of partition walls hold the terminal at the cutouts of the terminal.

5. The electrical connector according to any one of claims 1-4, wherein the connector housing is provided on both side walls of a rear portion of the terminal receiving section with a pair of projections, projecting inwardly from the terminal receiving section, for holding an electric wire.

6. The electrical connector according to claim 5, wherein the pair of projections are flexible in a radial direction of the electric wire.

7. A terminal comprising an electrical contact portion at one end thereof for connecting to a mating terminal and an electric wire joint portion at the other end for joining to an electric wire, wherein the electrical contact portion and the electric wire joint portion are connected by means of a flexible connecting part.

8. The terminal according to claim 7, wherein said flexible connecting part is formed into a sheet shape, extending from a bottom base plate of the electrical contact portion.

9. The terminal according to claim 7 or 8, wherein said flexible connecting part is provided, at the both sides, with a couple of cutouts and the width of said flexible connecting part is narrower than that of the bottom base plates of the electrical contact portion and that of the electric wire joint portion.
